(19) United States
(12) Patent Application Publication
(10) Pub. No.: US 2006/0220889 A1
(43) Pub. Date: Oct. 5, 2006

(54) Electronically controlled multi-sensor fluid detection and alarm device to reveal the presence or the arrival of a fluid at user defined locations

(76) Inventor: Daniel Taverney, Romanel-Lausanne (CH)

Correspondence Address: Daniel Taverney, En Esserpy 1, Romanel-Lausanne, 1032, CH

(21) Appl. No.: 11/386,756

(22) Filed: Mar. 23, 2006

(30) Foreign Application Priority Data
Mar. 29, 2005 (CH) 00532/05

(51) Int. Cl. G08B 21/00

(52) U.S. Cl. 340/612; 340/603; 73/40

(57) ABSTRACT

An electronically controlled multi-sensor fluid detection and signal emitting device, said signal being emitted when an electrically conductive fluid comes into contact with at least one of the sensors connected to the device.

### CROSS REFERENCE TO RELATED APPLICATION

This application claims the benefit of the priority date of the foreign application No. 00532/05 filed Mar. 29, 2005 with the Federal Institute of Intellectual Property in Bern, Switzerland, by the Swiss inventor Daniel Taverney.

### BACKGROUND OF THE INVENTION

1. Field of the Invention

The present invention pertains to the field of water detectors and alarms which sense the presence or the arrival of water at predefined locations. Such devices emitting an alarm to indicate that remedial actions should be taken.

2. Background Information

In this document, the terms “liquid”, “fluid” and “water” are used interchangeably. These terms define any non-flammable, electrically conductive fluid. When used, the term “water” comprises water from domestic distribution networks, rain water, aqueous mud, sea water, ground water, sewage etc. It excludes one hundred percent pure distilled water as such fluid does not have electrically conductive properties.

Appliances and equipment such as washers, water heaters and softeners, fridges, ice makers, freezers, fish tanks, hot tubs, sinks, toilet tanks, air conditioning units, sump pumps, etc. are well known for silently causing spillage and overflow that can stay undetected until they acquire a noticeable and hard to remedy magnitude. The device as per the invention is therefore meant to be used essentially in homes, offices, light industrial environments, libraries and archive rooms, air conditioned computer rooms, under raised floors of technical rooms, in the boat bilge, etc. to detect and signal the presence of unwanted water at given locations.

The objective of the invention is to provide a solution for instantly detecting and signalling the presence of liquid on flat surfaces as well as the arrival of a fluid at a defined level in containers. A single control unit can simultaneously monitor an unlimited number of locations by its ability to receive the connection of remote sensors using the connecting ports provided on the device's casing. The device can either be used as a surface detector, a level detector or both at the same time.

Other water detecting devices for similar purposes are known. To our knowledge, in their non-customized version, these devices do not allow an undefined number of sensors to be connected to the same control unit. They are limited to the monitoring of either a single flat horizontal surface or the monitoring of the water level in a single container. Some of these devices require that a substantial depth of water be present in order to trigger the alarm and some others require the use of tools in order to put the unit to work. The alarming sound of these devices is often continuous, and/or of low intensity, thus making the alarm purpose less effective. Also, on many of these devices the electronic control board is easily accessible by the user, thus raising a concern as far as reliability, children safety and product warranty are involved.

### SUMMARY OF THE INVENTION

The invention described in this document removes the limitations of the prior art outlined in the above paragraph and promotes improvements to extend the capabilities of such a device. These and other objects are achieved by the fluid detector and alarm described in this application. The main advantages of the invention are:

The ability of the device to accept the connection of one or a plurality of peripheral sensors by means of the connecting ports provided on the casing. All said peripheral sensors being monitored by the one and only electronic control board contained within said casing. These peripheral sensors, when connected, come in addition to the fixed and always active detector built around the device's body and meant to monitor flat surfaces. The alarm is triggered as soon as at least one or a plurality of the connected sensors reports the presence of a fluid at their location.

The device can either be used as a surface monitor only using its built-in detector, or as a remote monitor only using one or a plurality of peripheral detectors, or do all of these tasks simultaneously.

When used to monitor a horizontal surface, the detecting electrodes are in direct contact with said surface. The device therefore does not require a minimal depth of water to be present on that surface in order to trigger the alarm. The alarm signal is triggered even if a negligible quantity of water bridges both electrodes.

When used as a horizontal surface detector, the entire device can be directly deposited on the floor, at the foot of the equipment susceptible to causing a spill. Wall mounting or shelf depositing are not required. The device is standalone.

The bottom part of the casing is watertight and the assembly is designed to float if water reaches a certain depth, thus keeping the alarm function working, also saving the device from destruction from drowning in case of severe flooding.

The alarm sound is triggered within milliseconds after the fluid reaches both electrodes of a sensor. The sound is emitted as a series of beeps in order to better capture the attention. Sound intensity and beeping frequency are independent from the quantity and the nature of the detected fluid. The alarm stops when the sensor is removed from the fluid having triggered it. Resetting of the device is therefore not necessary.

The peripheral level sensor becomes active as soon as it is connected to a port on the main unit. Its connecting wire can be extended to any suitable length thus allowing monitoring a location many yards away from the device placed at hearing distance.

Other forms of execution of the device could trigger an acoustic signal, and/or a light signal and/or send electromagnetic waves to be picked up by a remote system.

Other objects and advantages of the present invention will become apparent to the mind of those skilled in this art from the following detailed description in which I have shown and described only the preferred embodiment of the invention by way of illustrations which I contemplated as being the best mode to carry out my invention. The invention is capable of modifications in various respects and aspects, all without departing from the invention. In accordance, the supplied drawings and description of the preferred embodiment are to be regarded as clarifying by use of examples and not as restrictive to these particular forms of execution.

### BRIEF DESCRIPTION OF THE DRAWINGS

The invention will be better understood from the study of the forms of execution, presented solely for example purposes and described by the drawings on which:

FIG. 1 depicts details of an execution of the remote level detector
FIG. 1-1: Lengthwise section of the body of the detector
FIG. 1-2: Side view of the body of the detector
FIG. 1-3: Front view of the detector's electrode
FIG. 1-4: Cross section of the detector's electrode
FIG. 1-5: Lengthwise section of the assembled detector
FIG. 1-6: Assembled detector

FIG. 2 depicts the device's casing in its sound emitting execution and represented with only one connecting port for remote sensors connection
FIG. 2-1: Front view of the casing
FIG. 2-2: Side view of the casing
FIG. 2-3: Rear view of the casing

FIG. 3 depicts the embodiment of the resounding and reverberating chamber
FIG. 3-1: Front view of the cover
FIG. 3-2: Section view of the cover showing details of resounding chamber

FIG. 4 represents an execution of an electrode composing the device's fixed detector

FIG. 5 is an artistic view in perspective of the device with its central control unit and a remote level detector ready to be connected to a port located on the casing

FIG. 6 depicts the schematic of the control electronics

### DETAILED DESCRIPTION OF THE INVENTION

The device as per the invention is a battery operated electronically controlled multi-sensor fluid detector and alarm. The battery and the controlling circuit board are embarked within the casing of the device. The latter's duty is to monitor user defined locations for the arrival of a fluid. Its purpose is to emit a signal when such event occurs. The fluid detection is carried out by sensors each of which features at least one pair of electrodes. The electronic board applies an opposed electric polarity to each electrode of each pair. In the absence of liquid, the system is in the open electrical state. When a fluid enters in contact with two electrodes of opposite polarity, a short circuit is created which instructs the electronic board to trigger a signal. In the forms of execution presented here, said signal triggers a sound emitting component. A plurality of sensors can be submitted to the electronic board of the device. When using the device to monitor a horizontal surface, the casing is simply deposited on said surface, its sound opening facing upwards and the metallic electrodes being in direct contact with the surface to supervise. When used for monitoring the rising level in a container, the connecting end of the level sensor is coupled with one of the ports of the casing, while the detecting end of the sensor is hung into the container and positioned at the level judged to be critical. The signal is triggered when the fluid reaches both electrodes of the sensor. The device can be used to monitor a flat surface only, one or a plurality of containers only, or do both simultaneously.

The device as per the invention is constituted of the following components:

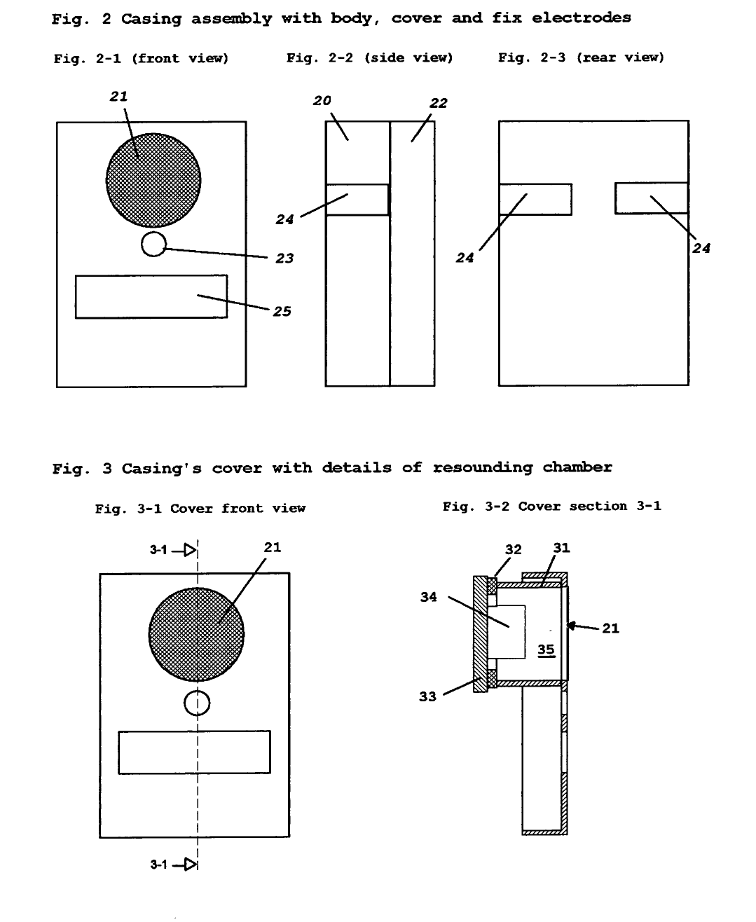

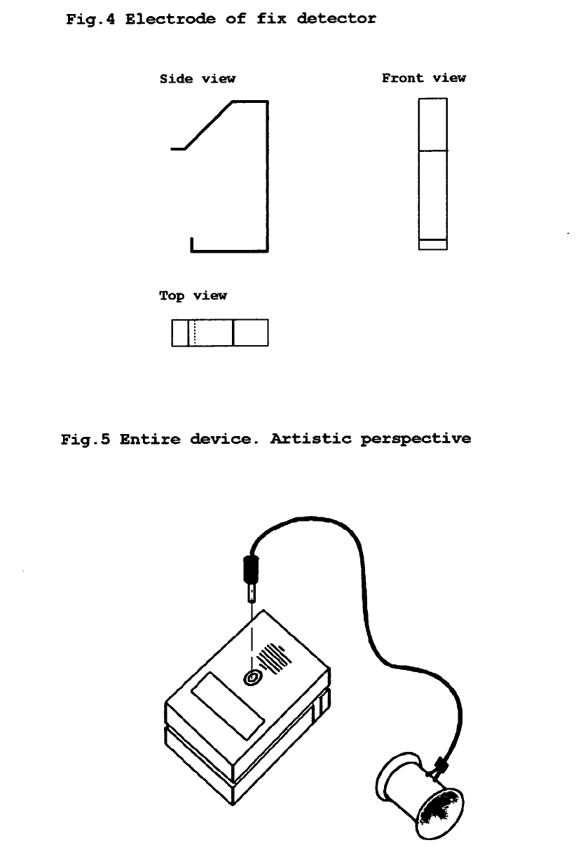

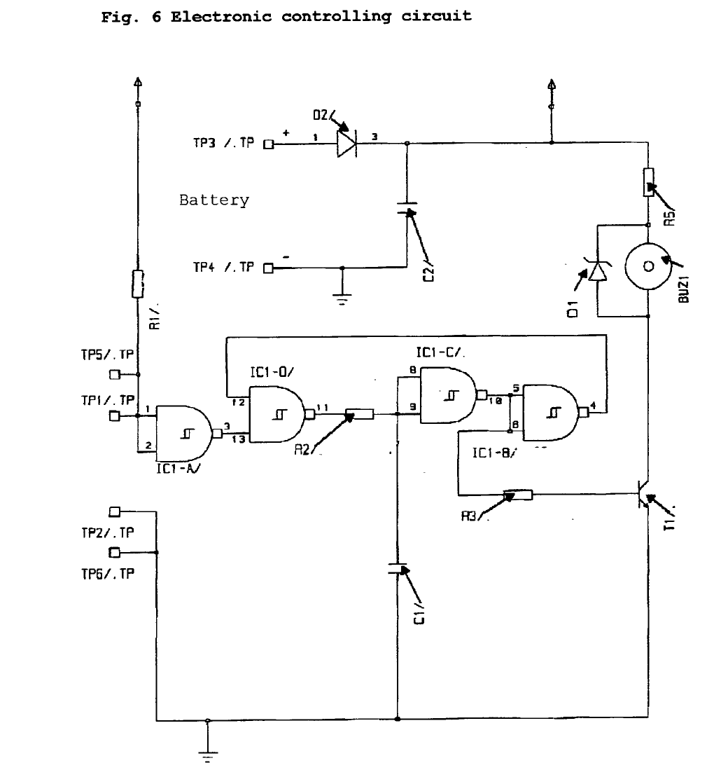

A casing FIG. 2 composed of a body 20 and a cover 22. Two electrodes 24 made of formed sheet metal are adjusted on the exterior of the body 20 as shown on FIG. 2-2 and FIG. 2-3; they enter the body at its upper part in order to be connected to the electronic board. These electrodes 24 constitute the fixed detector which is permanently activated when the device is in operation. A detailed view of the electrodes 24 is shown in FIG. 4.

One or a plurality of connecting ports 23 is mounted on the casing in order to allow for the submission of peripheral sensors to the electronics. Each port is electrically connected in parallel to the electronic board. These connectors 23 allow for the quick plugging/unplugging of peripheral sensors.

The cover 22 features an opening 21 permitting the propagation to the exterior of the sound emitted by the enunciator 34. The opening 25 of the cover 22 allows to easily access the battery which is housed within the body 20.

The rear of the cover FIG. 3 accommodates a tubular part 31 which is on the same axis as the opening 21. Said tubular part extends downwards until coming into close proximity to the electronic board 33. The latter is horizontally placed so that the enunciator 34, itself mounted on the electronic board 33, is contained within the tubular part 31. At assembly time, a compressible seal 32 is inserted in between the electronic board and the end of the tubular section 31. The volume thus created composes the resounding chamber 35. The inner assembly is kept in place when the cover 22 and the body 20 are joined to form the casing. The casing is designed and dimensioned in a manner to render the final assembly with the battery installed, balanced and buoyant.

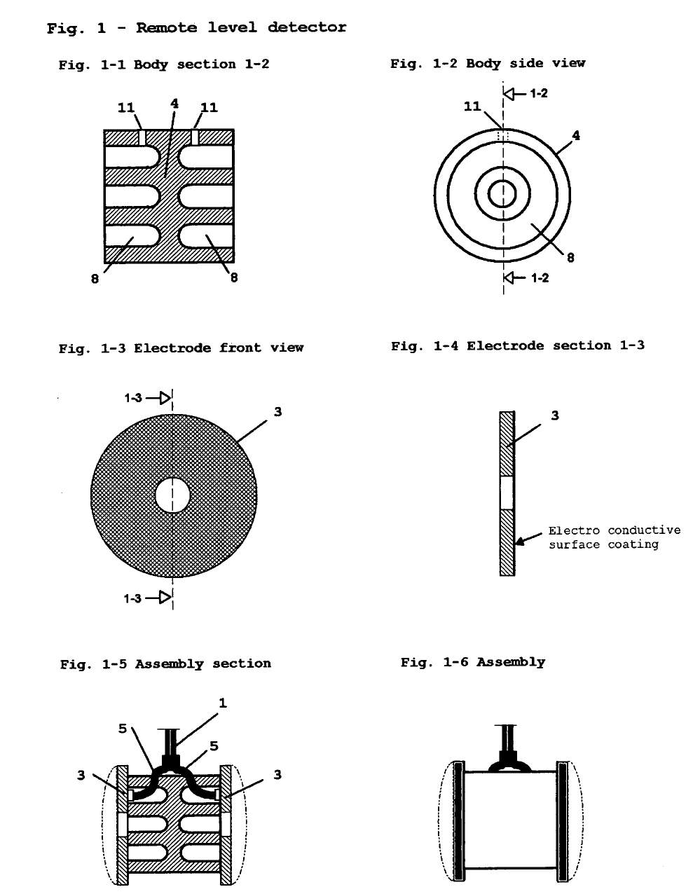

The peripheral level detector of FIG. 1 is composed of a body FIG. 1-1 and FIG. 1-2, of two electrodes FIG. 1-3 and FIG. 1-4 each of which is axially positioned at each extremity of the body 4. The radial dimensions of the electrodes must be greater than the ones of the body in order to expose part of their conducting material to the fluid. A cavity 8 is provided at each extremity of the body in order to give room for the passage of an electrical wire 5 and for the latter's connecting means to its corresponding electrode 3. The body is pierced by two radial holes 11, each finishing in each of above mentioned cavity 8. These holes are of sufficient diameter to accommodate the passing-through of a conducting wire 5. Each wire is then permanently connected to its corresponding electrode. The sensor's body and the electrodes are secured in a manner to form a fixed assembly. Lastly, both wires 5 are joined on the outside of the detector to form a cable 1 at the other end of which is provided a connector suitable with the connecting ports 23 of FIG. 2.

I claim:

1. An electronically controlled multi-sensor fluid detection and signal emitting device characterized by it comprising a two electrodes fixed sensor built onto the device's casing and a two electrodes peripheral sensor, said device has the ability to receive the connection of one or a plurality of peripheral sensors by means of one or a plurality of connecting ports entering its casing, said ports are wired to the electronic control board thus allowing all sensors to be supervised by the same electronic circuit, the latter being in charge of emitting a signal in case the presence of a fluid is detected by the fixed sensor and/or by one or a plurality of peripheral sensors connected to the device through said ports.

2. Device as per claim 1 characterized by a resounding chamber embodied within the casing by the use of a tubular part sharing the same vertical axis as the one of the sound propagation opening provided on the casing's cover, said tubular part being of length equal to the distance measured between the underside surface of the cover and the top surface of the electronic board located below it, the latter being horizontally positioned within the casing so that the enunciator mounted on the board ends up being situated inside the tubular part, the purpose of said resounding chamber being to minimize sound dissipation within the casing and to maximize the reverberation of sound waves towards the exterior.

3. Device as per claim 1 characterized by the electrodes of the fixed sensor which are made of sheet metal cut and formed in a manner to allow them to be mounted on the body starting at its bottom, extending upwards along the casing and entering the latter at some point of it in order to allow for each electrode to be connected to the electronic control board.

4. Device as per claim 1 characterized by the peripheral sensor composed of a two conductors cable featuring an electrical connector on one of its end and a sensor on the other, said sensor is composed of a body at each extremity of which is provided a cavity of sufficient volume to host a small portion of a conductor and the connecting means to its corresponding electrode, said body is pierced of two radial holes each ending up in each cavity and of sufficient diameter to accommodate for one conductor to be pushed through it in order to slightly protrude out of the corresponding cavity, two electrodes each of which is connected to a conductor and placed face-to-face to its nearest extremity of the body thus pushing the protruding portion of the cable and said connecting means into the cavity; all parts being joined to form an assembly.

5. Device as per one of the claims 1 and 4 characterized by the electrodes of the peripheral sensor which are made of synthetic material of which the faces can be coated with an electro-conductive material to which a component can be bonded using a soldering process, said electrodes having radial dimensions greater than the radial dimensions of the body in order to expose a portion of their electro-conductive surface to the fluid that may come into contact with them.
